(19) United States
(12) Patent Application Publication
(10) Pub. No.: US 2026/0141481 A1
(43) Pub. Date: May 21, 2026

(54) ELECTRONIC DEVICE AND METHOD WITH IMAGE RESOULTION INCREASE

(71) Applicant: Samsung Electronics Co., Ltd., Suwon-si (KR)

(72) Inventors: Peng DU, Xi’an (CN); Hui LI, Xi’an (CN); Han XU, Xi’an (CN); Ran YANG, Xi’an (CN); Dongwook LEE, Suwon-si (KR); Dae Hyun JI, Suwon-si (KR); Paulbarom JEON, Suwon-si (KR)

(73) Assignee: Samsung Electronics Co., Ltd., Suwon-si (KR)

(21) Appl. No.: 19/353,109

(22) Filed: Oct. 8, 2025

(30) Foreign Application Priority Data
Nov. 15, 2024 (CN) 202411638893.2
Jul. 28, 2025 (KR) 10-2025-0102423

(51) Int. Cl. G06T 3/4053; G06T 5/60; G06T 5/70

(52) U.S. Cl. CPC G06T 3/4053; G06T 5/60; G06T 5/70; G06T 2207/20064; G06T 2207/20084

(57) ABSTRACT

An electronic device includes one or more processors comprising processing circuitry, and memory comprising one or more storage media storing instructions that, when executed individually or collectively by the one or more processors, cause the electronic device to determine a first spectrum comprising a plurality of frequency components for an image containing noise determined at each of a plurality of levels by transforming the image into a frequency domain at the plurality of levels, determine a plurality of tokens for a plurality of patches by segmenting the first spectrum into the plurality of patches and encoding the plurality of patches based on positions of corresponding patches, denoise the plurality of tokens based on the image, determine a second spectrum obtained by denoising the first spectrum, based on the plurality of denoised tokens, and generate a high-resolution (HR) image with an increased resolution of the image by inversely transforming the second spectrum into a spatial domain at the plurality of levels.

### CROSS-REFERENCE TO RELATED APPLICATIONS

This application claims the benefit under 35 USC § 119 (a) of Chinese Patent Application No. 202411638893.2, filed on Nov. 15, 2024 in the China National Intellectual Property Administration, and Korean Patent Application No. 10-2025-0102423, filed on Jul. 28, 2025 in the Korean Intellectual Property Office, the entire disclosures of which are incorporated herein by reference for all purposes.

### BACKGROUND

### 1. Field

The following description relates to an electronic device and method with image resolution increase.

### 2. Description of Related Art

In the field of computer image processing, super-resolution (SR) of single images may be used. As Images, one of the important information transmission media, may have to sacrifice image quality during transmission. In the process of degrading a high-resolution (HR) image into a low-resolution (LR) image with a smaller capacity, some high-frequency information in the image may be lost. SR may refer to a technique that transforms an LR image into an HR image by processing the information lost in the image. For example, image SR may refer to a technique of upsampling an LR image to restore the corresponding HR image. For example, image SR may be achieved through a post-upsampling, pre-upsampling, or residual-based SR method. However, while the post-upsampling method may realize mapping from the LR image to the HR image, the training difficulty of the mapping of the post-upsampling method is high because the sizes of the input image and the output image of the network do not match. Further, the pre-upsampling method may introduce noise due to the upsampling of the LR image, which may degrade the quality of SR results. Further, the residual-based SR method may require extensive time and resources to train two networks separately. Furthermore, some methods (e.g., Diwa's method, Waveface's method, etc.) still need to learn SR performance of low-frequency components in LR images. The implicit mapping from LR images to HR images in typical methods may result in lower fidelity in the SR results.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, an electronic device includes one or more processors comprising processing circuitry, and memory comprising one or more storage media storing instructions that, when executed individually or collectively by the one or more processors, cause the electronic device to determine a first spectrum comprising a plurality of frequency components for an image containing noise determined at each of a plurality of levels by transforming the image into a frequency domain at the plurality of levels, determine a plurality of tokens for a plurality of patches by segmenting the first spectrum into the plurality of patches and encoding the plurality of patches based on positions of corresponding patches, denoise the plurality of tokens based on the image, determine a second spectrum obtained by denoising the first spectrum, based on the plurality of denoised tokens, and generate a high-resolution (HR) image with an increased resolution of the image by inversely transforming the second spectrum into a spatial domain at the plurality of levels.

For the determining of the first spectrum, the execution of the instructions may cause the electronic device to perform a wavelet transform on the image at a first level among the plurality of levels, and perform a wavelet transform on a low-frequency component determined through the wavelet transform at a previous level of a corresponding level, at each of remaining levels among the plurality of levels, excluding the first level.

The plurality of patches may include a patch representing a low-frequency component determined at a last level among the plurality of levels and patches representing high-frequency components determined at the remaining levels among the plurality of levels, excluding the last level.

For the denoising of the plurality of tokens, the execution of the instructions may cause the electronic device to determine a token for the image by encoding the image, and based on the token for the image, determine a token for the patch representing the low-frequency component and tokens for the patches representing the high-frequency components.

For the determining of the second spectrum, the execution of the instructions may cause the electronic device to sample the plurality of tokens into a predetermined number of tokens to perform denoising by performing cross attention on the plurality of tokens.

For the determining of the second spectrum, the execution of the instructions may cause the electronic device to determine the plurality of denoised tokens by performing grid-sampling on the sampled tokens, and determine the second spectrum based on the plurality of denoised tokens using a fully connected layer.

For the denoising of the plurality of tokens, the execution of the instructions may cause the electronic device to denoise the plurality of tokens using a decoder comprising a plurality of diffusion transformer (DiT) blocks.

For the determining of the plurality of tokens for the plurality of patches, the execution of the instructions may cause the electronic device to determine a patch size corresponding to each level based on a predetermined minimum patch size and each level number of the plurality of levels, and segment each level of the first spectrum into the plurality of patches according to the corresponding patch size.

For the determining of the plurality of tokens, the execution of the instructions may cause the electronic device to encode the plurality of patches based on a level number for a corresponding patch for each of the patches, a position of the corresponding patch within a corresponding level of the first spectrum, a position of the corresponding patch on a vertical axis, and a position of the corresponding patch on a horizontal axis.

The execution of the instructions may cause the electronic device to increase the resolution of the image by performing a plurality of iterations of the determining of the first spectrum for the image to the generating of the HR image a predetermined number of iterations, wherein the generated HR image of an iteration is the image of a subsequent iteration.

In one or more general aspects, a processor-implemented method includes determining a first spectrum comprising a plurality of frequency components for an image containing noise determined at each of a plurality of levels by transforming the image into a frequency domain at the plurality of levels, determining a plurality of tokens for a plurality of patches by segmenting the first spectrum into the plurality of patches and encoding the plurality of patches based on positions of corresponding patches, denoising the plurality of tokens based on the image, determining a second spectrum obtained by denoising the first spectrum, based on the plurality of denoised tokens, and generating a high-resolution (HR) image with an increased resolution of the image by inversely transforming the second spectrum into a spatial domain at the plurality of levels.

The determining of the first spectrum may include performing a wavelet transform on the image at a first level among the plurality of levels, and performing a wavelet transform on a low-frequency component determined through the wavelet transform at a previous level of a corresponding level, at each of remaining levels among the plurality of levels, excluding the first level.

The plurality of patches may include a patch representing a low-frequency component determined at a last level among the plurality of levels and patches representing high-frequency components determined at the remaining levels among the plurality of levels, excluding the last level.

The denoising of the plurality of tokens may include determining a token for the image by encoding the image, and based on the token for the image, determining a token for the patch representing the low-frequency component and tokens for the patches representing the high-frequency components.

The determining of the second spectrum may include sampling the plurality of tokens into a predetermined number of tokens to perform denoising by performing cross attention on the plurality of tokens.

The determining of the second spectrum may include determining the plurality of denoised tokens by performing grid-sampling on the sampled tokens, and determining the second spectrum based on the plurality of denoised tokens using a fully connected layer.

The denoising of the plurality of tokens may include denoising the plurality of tokens using a decoder comprising a plurality of diffusion transformer (DiT) blocks.

The determining of the plurality of tokens for the plurality of patches may include determining a patch size corresponding to each level based on a predetermined minimum patch size and each level number of the plurality of levels, and segmenting each level of the first spectrum into the plurality of patches according to the corresponding patch size.

The determining of the plurality of tokens may include encoding the plurality of patches based on a level number for a corresponding patch for each of the patches, a position of the corresponding patch within a corresponding level of the first spectrum, a position of the corresponding patch on a vertical axis, and a position of the corresponding patch on a horizontal axis.

In one or more general aspects, a processor-implemented method includes generating, using a wavelet transform, a low-frequency component and a high-frequency component of an image, performing, based on a low-resolution (LR) image, denoising on tokens respectively corresponding to the low-frequency component and the high-frequency component, generating, based on the denoised tokens, a low-frequency component and a high-frequency component of a high-resolution (HR) image, and generating, using an inverse wavelet transform, the HR image based on the low-frequency component and the high-frequency component of the HR image.

Other features and aspects will be apparent from the following detailed description, the drawings, and the claims.

### BRIEF DESCRIPTION OF THE DRAWINGS

FIG. 1 illustrates an example of an operating method of an electronic device according to one or more embodiments.

FIG. 2 illustrates an example of time steps for processing an image by an electronic device according to one or more embodiments.

FIG. 3 illustrates an example of operations of an electronic device performed in each time step according to one or more embodiments.

FIG. 4 illustrates an example of a multi-level discrete wavelet transform (MDWT) and an inverse MDWT (IMDWT) according to one or more embodiments.

FIG. 5 illustrates an example of a plurality of levels of an MDWT according to one or more embodiments.

FIG. 6 illustrates an example of an operation of determining a first spectrum from an image according to one or more embodiments.

FIG. 7 illustrates an example of an operation of segmenting a first spectrum into a plurality of patches according to one or more embodiments.

FIG. 8 illustrates an example of an operation of encoding a plurality of patches of a first spectrum according to one or more embodiments.

FIG. 9 illustrates an example of an operation of sampling a plurality of tokens for each of a plurality of patches according to one or more embodiments.

FIGS. 10 and 11 illustrate an example of an operation of denoising a plurality tokens according to one or more embodiments.

FIG. 12 illustrates an example of an operation of reconstructing sampled tokens according to one or more embodiments.

FIG. 13 illustrates an example of an electronic device according to one or more embodiments.

FIG. 14 illustrates an example of an electronic device according to one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein.

However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and specifically in the context on an understanding of the present disclosure. Terms, such as those defined in commonly used dictionaries, are to be interpreted as having a meaning that is consistent with their meaning in the context of and specifically in the context of the present disclosure, and are not to be construed to have an ideal or excessively formal meaning unless otherwise defined herein.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example”, “embodiment”, and “example embodiment” herein have a same meaning (e.g., the phrasing ‘in an or one example’ has a same meaning as ‘in an or one embodiment” and ‘in an or one example embodiment’), and “one or more examples” has a same meaning as “one or more embodiments” and “one or more example embodiments”. Still further, each of multiple or all separately described an/one “example”, “embodiment”, “example embodiment”, as well as “examples”, “embodiments”, “example embodiments”, herein may be included, in combination, in a same embodiment in any combination.

Hereinafter, examples will be described in detail with reference to the accompanying drawings. When describing the examples with reference to the accompanying drawings, like reference numerals refer to like elements and a repeated description related thereto will be omitted.

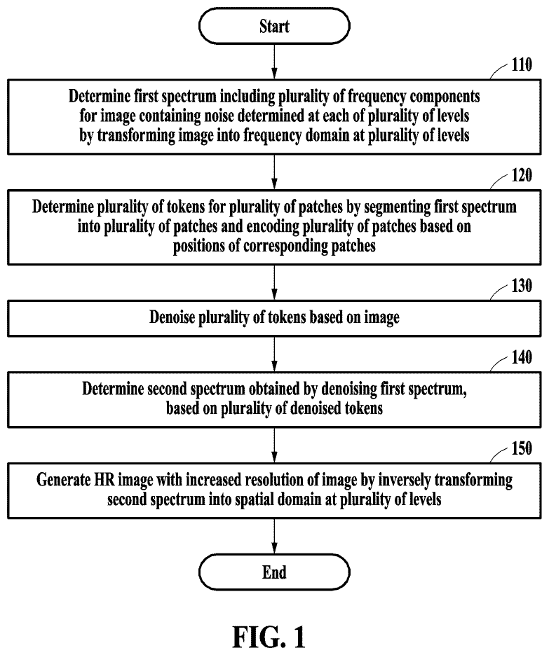

FIG. 1 illustrates an example of an operating method of an electronic device according to one or more embodiments.

Referring to FIG. 1, an electronic device may perform operations 110 to 150 to increase a resolution of an image.

The electronic device and method of one or more embodiments may solve the technological problems of typical electronic devices and methods by providing an image processing technology (or an image processing model framework-a transformer-based diffusion model of a multi-level wavelet (multi-level wavelet diffusion transformer (MWDT)) that exhibits more excellent performance in both fidelity and quality, and in particular, provides an image processing method, an image processing apparatus, an electronic device, and a storage medium used for image SR.

The electronic device and method of one or more embodiments may perform the image SR processing on LR images using a framework that combines a diffusion model and a transformer, thereby obtaining high-quality and high-fidelity SR images. For example, by utilizing the multi-level wavelet transform, the electronic device and method of one or more embodiments may divide image SR processing into mapping low-frequency components from LR images and generating high-frequency components under the guide of the LR images, process the low-frequency components and the high-frequency components separately, and generate an HR image by integrating the processed low-frequency and high-frequency components, thereby generating an HR image with higher quality and fidelity with less computational effort. By separating the high-frequency components by level (or layer) through the multi-level wavelet transform processing, and/or by adding high-frequency components in the image SR process, the electronic device and method of one or more embodiments may construct a model in a manner aligned with the SR process, and the electronic device and method of one or more embodiments may generate an image SR model with higher interpretability, and may generate processing results with more excellent fidelity and quality.

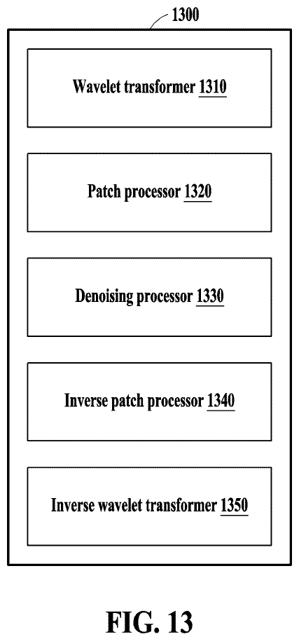

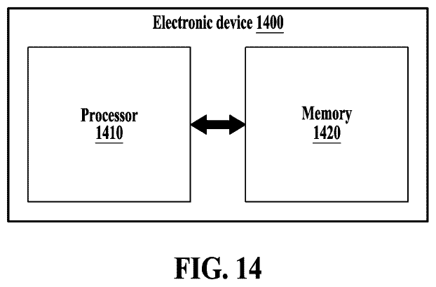

An electronic device (e.g., an electronic device 1300 of FIG. 13 and/or an electronic device 1400 of FIG. 14) may be or include various computing devices, such as a mobile phone, a smartphone, a tablet personal computer (PC), an e-book device, a laptop, a PC, a desktop, a workstation, and/or a server, various wearable devices, such as a smart watch, smart eyeglasses, a head-mounted display (HMD), and/or smart clothing, various home appliances such as a smart speaker, a smart television (TV), and/or a smart refrigerator, and other devices, such as a smart vehicle, a smart kiosk, an Internet of things (IOT) device, a walking assist device (WAD), a drone, and/or a robot, but examples are not limited thereto. For ease of description, the electronic device may also be referred to as an image processing apparatus.

According to an example, an electronic device may generate a high-resolution (HR) image by increasing a resolution of a low-resolution (LR) image through operations 110 to 150. For example, the electronic device may generate an HR image through a multi-level discrete wavelet transform (MDWT) using a diffusion model and a transformer. The electronic device may map the LR image to a low-frequency component of the image using the MDWT, and determine a high-frequency component of the image based on the LR image. The electronic device of one or more embodiments may process the low-frequency component and the high-frequency component of the image separately, and combine the processed low-frequency component and high-frequency component to generate an HR image with a higher resolution and fidelity with less computation than a typical electronic device, thereby improving processing speed and reducing memory space requirements. In an example, the electronic device may denoise high-frequency components of an image separately for each level (or for each layer) through the MDWT and add the denoised high-frequency components to the image, thereby determining an HR image.

Here, the diffusion model may be a generative model for an image. The diffusion model may add noise (e.g., Gaussian noise) to an original image in a forward process (or a diffusion process), and obtain a reverse process (or a reverse diffusion process, inference process, and/or denoising process) through training. In an example, an image processing method of the electronic device may be a processing process that is repeatedly performed in the reverse process of the diffusion model.

Here, a diffusion transformer (DiT) may be a transformer-based diffusion model which may denoise input tokens using a DiT block to obtain denoised tokens.

Here, a patch may be determined by segmenting an image. In an example, convolution operations may be performed on individual patches.

Here, a token may be determined by encoding the patch for transformer processing. In an example, the token may represent a token obtained by applying positional encoding to a patch of an image.

Here, a spatial domain image may represent a spatial domain image in an original space of an image. For example, the spatial domain image may be a red, green, blue (RGB) image. For example, although the drawings are not drawn in color, the spatial domain image and an image corresponding to a low-frequency component of a spectrum may be understood as an RGB image, and an image corresponding to a high-frequency component of the spectrum may be understood as a black-and-white image, but the examples are not limited thereto.

Here, the spectrum may represent a frequency domain or a frequency domain image. In an example, the spectrum may represent a frequency domain image determined through a wavelet transform. Here, for convenience of description, the wavelet spectrum may also be referred to as a spectrum or a frequency domain image.

The operations illustrated in FIG. 1 may be performed sequentially but not necessarily. For example, the order of the operations may change, and at least two of the operations may be performed in parallel. Operations 110 to 150 may be performed by at least one component (e.g., a processor) of an electronic device.

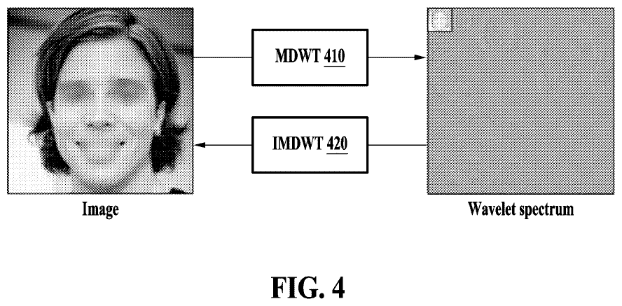

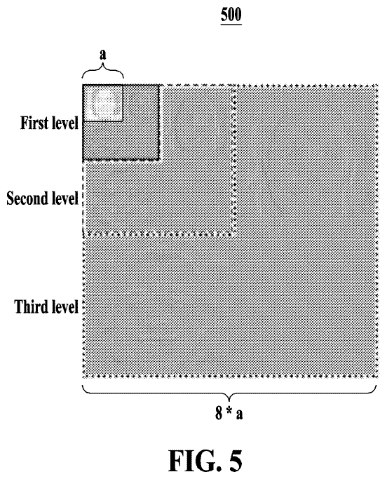

In operation 110, the electronic device may determine a first spectrum including a plurality of frequency components for an image containing noise determined at each of a plurality of levels by transforming the image into a frequency domain at the plurality of levels. According to an example, the electronic device may determine a first multi-level wavelet spectrum by performing the MDWT on a first spatial domain image containing noise. For example, the electronic device may transform a spatial domain image, which is an RGB image, into a first spectrum of a frequency domain in a stepwise manner through the MDWT. Here, for convenience of description, the first multi-level wavelet spectrum may also be referred to as the first spectrum. The electronic device may use the MDWT as a method of transforming an image into a frequency domain at a plurality of levels, but examples are not limited thereto, and various methods capable of transforming into the frequency domain may be used. One or more examples of operation 110 will be described in detail below with reference to FIGS. 4 and 5.

In operation 120, the electronic device may determine a plurality of tokens for a plurality of patches by segmenting the first spectrum into the plurality of patches and encoding the plurality of patches based on positions of corresponding patches. According to an example, the electronic device may perform patch processing on the first multi-level wavelet spectrum to determine the plurality of tokens containing noise including a low-frequency component containing noise and a high-frequency component containing noise. Here, the token containing noise may represent a token for an image containing noise, and may also be referred to as a token to which noise is added (or an undenoised token). In addition, the low-frequency component containing noise may also be referred to as a component containing low-frequency noise, and the high-frequency component containing noise may also be referred to as a component containing high-frequency noise.

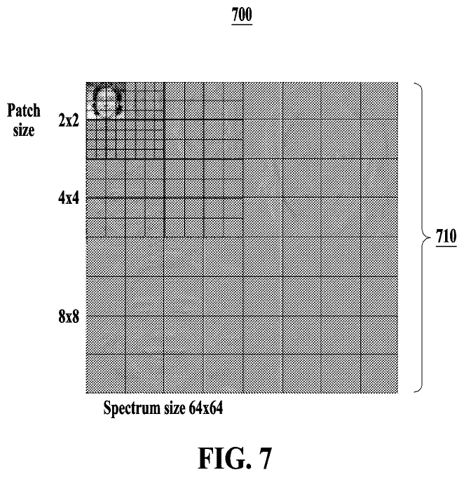

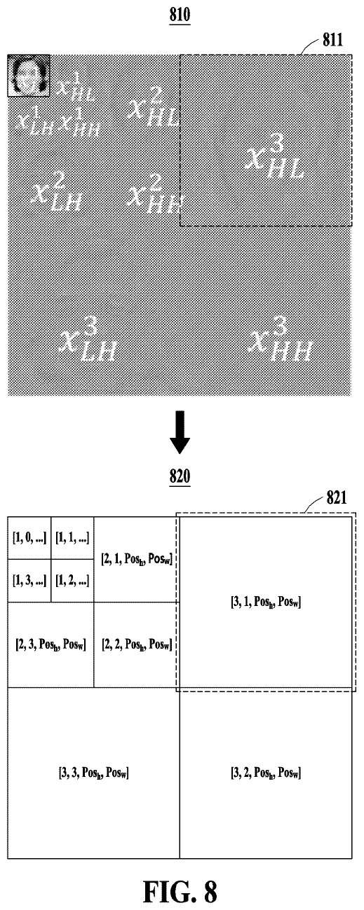

According to an example, in operation 120, the electronic device may perform patch processing on the multi-level wavelet spectrum of the image containing noise to determine tokens containing noise available for transformer processing. Here, the token containing noise may include a token containing low-frequency noise corresponding to the low-frequency component containing noise and a token containing high-frequency noise corresponding to a high-frequency component containing noise. One or more examples of operation 120 will be described in detail below with reference to FIGS. 7 and 8.

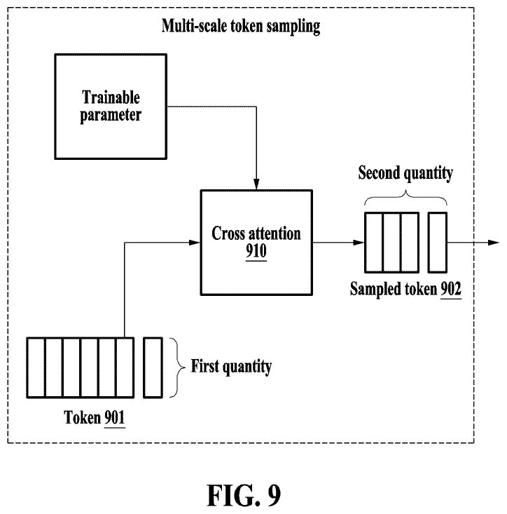

In operation 130, the electronic device may denoise the plurality of tokens based on the image. The electronic device may denoise the plurality of tokens containing noise to determine a plurality of denoised tokens including a denoised low-frequency component and a denoised high-frequency component. The electronic device may separate a low-frequency component and a high-frequency component from an image using the wavelet transform, and perform the denoising on tokens respectively corresponding to the low-frequency component and the high-frequency component based on a guide of an LR image, thereby implementing image super-resolution (SR). One or more examples of operation 130 will be described in detail below with reference to FIGS. 9 to 11.

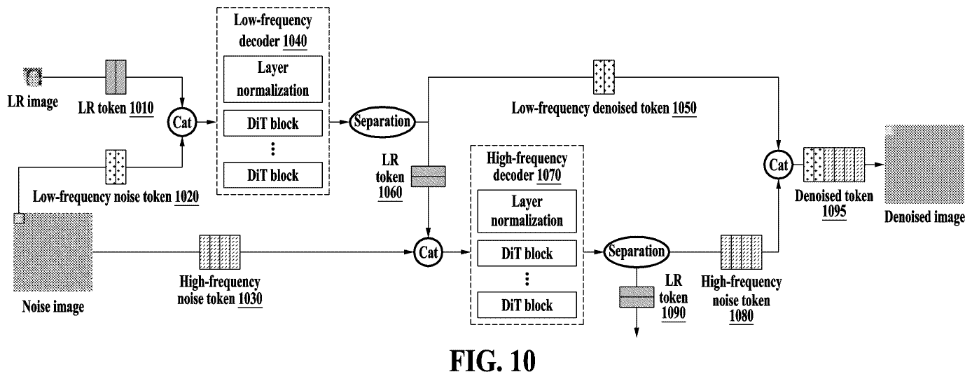

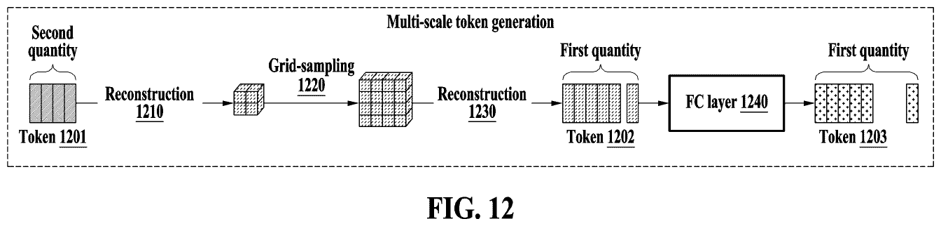

In operation 140, the electronic device may determine a second spectrum by denoising the first spectrum, based on the plurality of denoised tokens. The electronic device may determine a second multi-level wavelet spectrum by performing inverse patch processing on the plurality of denoised tokens. Here, for convenience of description, the second multi-level wavelet spectrum may also be referred to as the second spectrum. Operation 140 may correspond to the inverse processing of operation 120. For example, operation 140 may include an inverted pyramid tokenizer operation corresponding to the inverse processing of a pyramid tokenizer operation and a multiple scale token generation operation corresponding to the inverse processing of a multiple scale token sampling (MSTS) operation. One or more examples of operation 140 will be described in detail below with reference to FIGS. 10 and 12.

In operation 150, the electronic device may generate an HR image with an increased resolution of the image by inversely transforming the second spectrum into a spatial domain at the plurality of levels. The electronic device may generate an HR second spatial domain image by performing an inverse MDWT (IMDWT) on a denoised multi-level wavelet spectrum. The electronic device may repeatedly perform operations 110 to 150 using the second spatial domain image as the first spatial domain image of operation 110. The electronic device may add noise to the second spatial domain image in a current time step and then use the second spatial domain image with the noise added, as the first spatial domain image in a next time step.

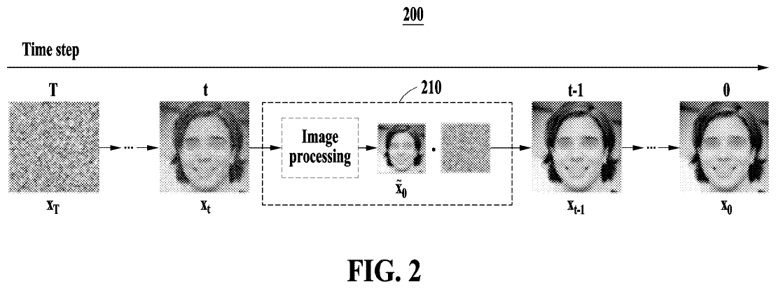

FIG. 2 illustrates an example of time steps for processing an image by an electronic device according to one or more embodiments.

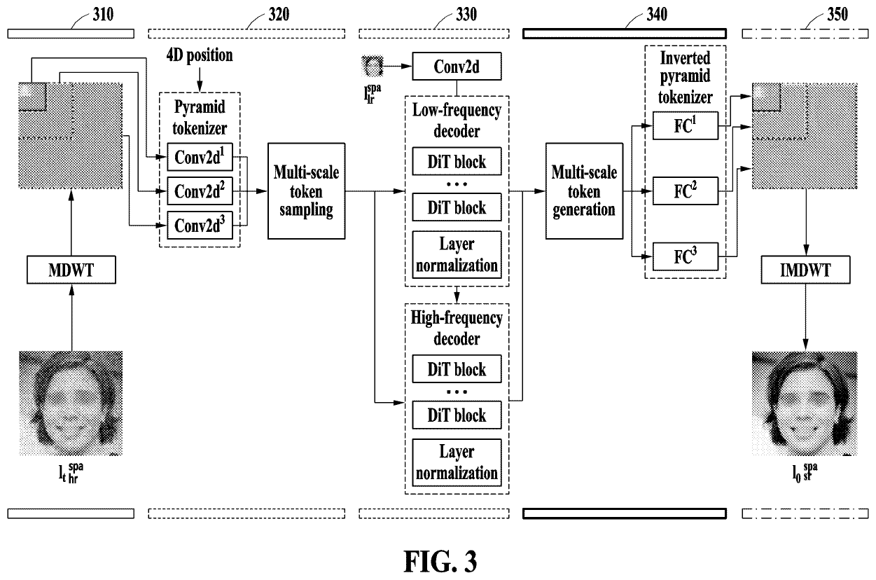

Referring to FIG. 2, the electronic device may generate an SR image x₀ by repeatedly performing the operations of FIG. 1 on an initial noise image x_{T} until a predetermined maximum number of iterations T is reached, using the transformer-based diffusion model. In FIG. 2, image processing operations 210 may be performed in each of time steps 200 from “T” to “0.” One or more examples of image processing operations 210 corresponding to one time step will be described in detail with reference to FIG. 3.

According to an example, the first spatial domain image containing noise in the current time step may be an image obtained by adding noise to an initial LR image, or an image obtained by adding noise to the second spatial domain image in a previous time step. For example, a spatial domain image xₜ (e.g., the first spatial domain image) containing noise as an input in a time step t may be an image with noise added corresponding to a spatial domain image output in a time step t+1, and a spatial domain image xₜ₋₁ (e.g., the second spatial domain image) as an output may contain noise added and may be used for denoising processing in a time step t-1.

FIG. 3 illustrates an example of operations of an electronic device performed in each time step according to one or more embodiments.

Referring to FIG. 3, image processing operations 310, 320, 330, 340, and 350 performed by the electronic device of FIG. 2 in one time step will be illustrated as an example. In an example, operations 310 to 350 may correspond to operations 110 to 150 of FIG. 1, respectively. In FIG. 3,

$${I}_{{t}_{hr}^{spa}}$$

may represent a first spatial domain image input in the time step t,

$${I}_{{0}_{sr}^{spa}}$$

may be a second spatial domain image that is output, and

$${I}_{lr}^{spa}$$

may represent an LR image, to which noise is not added.

In operation 310, the electronic device may determine a first multi-level wavelet spectrum by performing the MDWT on the first spatial domain image

$${I}_{{t}_{hr}^{spa}}$$

of HR containing noise.

In operation 320, the electronic device may perform patch processing on the determined first multi-level wavelet spectrum to determine the plurality of tokens containing noise including a low-frequency component containing noise and a high-frequency component containing noise. For example, the electronic device may perform the patch processing on the multi-level wavelet spectrum of an image containing noise to determine a plurality of tokens available for transformer processing.

Considering the high computational cost of a transformer, the electronic device of one or more embodiments may use a pyramid tokenizer for the wavelet spectrum to reduce the number of tokens, thereby reducing the computational cost without affecting the result quality. For example, the electronic device may segment the first multi-level wavelet spectrum into the plurality of patches by setting patch sizes differently. The electronic device may set a pyramid patch size for a frequency sub-band at different levels by considering the sparsity of high-frequency components and the density of low-frequency components. For example, the electronic device may apply a smaller patch size to a frequency component with dense information, and may apply a larger patch size to a frequency component with sparse information. To learn a relationship between different frequency components more effectively, each patch size may have the same receptive field. Here, a patch of a wavelet spectrum may also be referred to as a block.

According to an example, the predetermined number of the determined plurality of tokens may be sampled. For example, when the sizes of input LR images are different from each other, the number of tokens containing noise determined from the LR images may be different. For the convenience of model training, a MSTS method for different numbers of tokens may be used to process single image super-resolution (SISR) with various magnification scales.

In operation 330, the electronic device may denoise the plurality of tokens containing noise to determine a plurality of denoised tokens including a denoised low-frequency component and a denoised high-frequency component. The electronic device may determine the plurality of denoised tokens by performing the denoising on each of tokens containing low-frequency noise and tokens containing high-frequency noise based on the LR image

$${I}_{{t}_{lr}^{spa}} ,$$

to which noise is not added, corresponding to the first spatial domain image. For example, the electronic device may perform the denoising on the plurality of tokens based on a DiT image generation model of a guide condition on the LR image, to which noise is not added. In an example, the image input in each time step may be a first spatial domain image, to which noise is added, and the LR image, to which noise is not added, may be an image before the noise is added to the first spatial domain image.

In operation 340, the electronic device may determine a second multi-level wavelet spectrum by performing inverse patch processing on the plurality of denoised tokens. Operation 340 may be the inverse processing of operation 320. For example, operation 340 may include an operation of an inverted pyramid tokenizer corresponding to the operation of the pyramid tokenizer of operation 320 and a multiple scale token generation operation corresponding to the MSTS operation.

In operation 350, the electronic device may determine the HR second spatial domain image

$${I}_{{0}_{sr}^{spa}}$$

by performing the IMDWT on the second multi-level wavelet spectrum. The electronic device may add noise to the determined second spatial domain image in a current time step and then use the second spatial domain image with the noise added, as the first spatial domain image of repeated operations in a next time step. The electronic device may increase the resolution of the image by repeatedly performing operations 310 to 350 a maximum number of iterations for each time step.

FIG. 4 illustrates an example of an MDWT and an IMDWT according to one or more embodiments.

Referring to FIG. 4, the electronic device may transform an image of a spatial domain into a wavelet spectrum of a frequency domain through an MDWT 410, and may transform the wavelet spectrum of the frequency domain into the image of the spatial domain through an IMDWT 420. However, the MDWT and the IMDWT are only examples for description, and examples are not limited thereto, and the electronic device may transform the image into the spatial domain and the frequency domain through various transformation methods.

In an example, the MDWT 410 and the IMDWT 420 may be inverse transforms of each other. The MDWT 410 may represent a process of separating low-frequency information and high-frequency information from an image by performing the wavelet transform on the image at each of a plurality of levels (e.g., layers or hierarchies). The spatial domain image may be transformed into a wavelet spectrum of the frequency domain through the MDWT 410. The IMDWT 420 may represent a process of adding high-frequency information to low-frequency information similar to SISR. The wavelet spectrum of the frequency domain may be restored into an image of the spatial domain through the IMDWT 420. In an example, the SR processing performed on the entire multi-level wavelet spectrum may have an equivalent symmetric structure.

FIG. 5 illustrates an example of a plurality of levels of an MDWT according to one or more embodiments.

Referring to FIG. 5, the electronic device may determine a first spectrum 500 by transforming an image into a frequency domain at a plurality of levels.

According to an example, the electronic device may determine a maximum level number for the MDWT based on an SR magnification scale for the first spatial domain image. For example, the electronic device may determine a maximum level number I for the MDWT by Equation 1 below, for example.

$$l = ceil ( {log}_{2} b / a ) \qquad Equation 1$$

Here, a may represent a size of an LR image, a×a, b may represent a size of an HR image, b×b, and ceil( ) may represent a rounding function.

The electronic device may determine a magnification factor s=b/a for SR based on the size of the LR image and the size of the HR image. For example, when the size of the LR image is a=16 and the magnification factor is s=8, the size of the HR image may be 128×128 and the maximum level number may be I=3.

According to an example, when the first spatial domain image input in the time step t is

$${I}_{{t}_{hr}^{spa}} ,$$

the electronic device may perform the MDWT 410 by Equation 2 below, for example, and determine a low-frequency component

$${x}_{L}^{1}$$

containing noise determined, and a high-frequency component set X_{H} containing noise of one or more high-frequency components

$${X}_{H}^{j}$$

containing noise.

$${x}_{L}^{1} , {X}_{H} = MDWT ( {I}_{{t}_{hr}^{spa}} , l )$$

Here, MDWT( ) may represent the MDWT, I may represent the maximum level number of the MDWT, the high-frequency component

$${X}_{H}^{j}$$

may be

$${X}_{H}^{j} = \{ {x}_{L H}^{j} , {x}_{HL}^{j} , {x}_{HH}^{j} \} , j ∈ \{ 1 , l \} {,}_{j}$$

may represent the level number, LH may represent a lower left end, HL may represent an upper right end, and HH may represent a lower right end. For example,

$${x}_{L H}^{j}$$

may represent a high-frequency component at the lower left end of the wavelet spectrum of the level j, and the high-frequency component set may be

$${X}_{H} = \{ {X}_{H}^{j} \} , j ∈ \{ 1 , l \} .$$

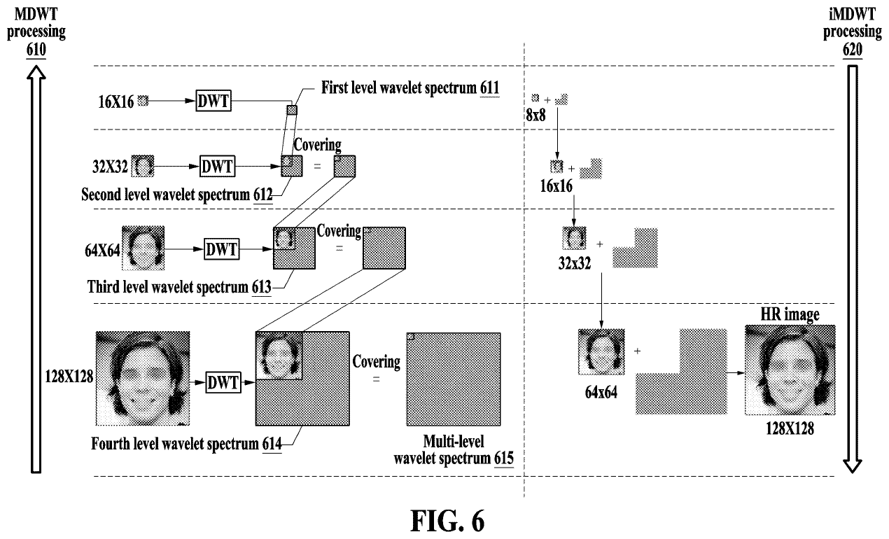

FIG. 6 illustrates an example of an operation of determining a first spectrum from an image according to one or more embodiments.

Referring to FIG. 6, the process of an MDWT 610 and an IMDWT 620 with the level number of 4 and wavelet spectra 611, 612, 613, 614, and 615 determined in each process are illustrated as an example. In the example of FIG. 6, the process of the MDWT 610 and the IMDWT 620 with the level number of 4 for an image having a size of 128×128 is illustrated for description, but examples are not limited thereto.

The electronic device may perform the wavelet transform on the image at a first level (e.g., a fourth level) among the plurality of levels, and, at each of the remaining levels except for the first level among the plurality of levels, perform the wavelet transform on the low-frequency component determined through the wavelet transform at a previous level of a corresponding level.

In the example of FIG. 6, the electronic device may determine a fourth level wavelet spectrum 614 by performing the wavelet transform on a 128×128 LR image. Here, a 64×64 image (e.g., an RGB image) at the upper left end of the fourth level wavelet spectrum 614 may correspond to the low-frequency spectrum (a spectrum corresponding to the low-frequency component), and a shaded image in the remaining portion may correspond to the high-frequency spectrum (a spectrum corresponding to the high-frequency component). The electronic device may a third level wavelet spectrum 613 by performing a discrete wavelet transform (DWT) on a 64×64 low-frequency spectrum of the fourth level wavelet spectrum 614. A 32×32 image on the upper left end of the third level wavelet spectrum 613 may correspond to the low-frequency spectrum, and a shaded image in the remaining portion may correspond to the high-frequency spectrum. The electronic device may determine a second level wavelet spectrum 612 by performing the DWT on the 32×32 low-frequency spectrum of the third level wavelet spectrum 613. A 16×16 image on the upper left end of the second level wavelet spectrum 612 may correspond to the low-frequency spectrum, and a shaded image in the remaining portion may correspond to the high-frequency spectrum. The electronic device may determine a first level wavelet spectrum 611 by performing the DWT on the 16×16 low-frequency spectrum of the second level wavelet spectrum 612. A 8×8 image on the upper left end of the first level wavelet spectrum 611 may correspond to the low-frequency spectrum, and a shaded image in the remaining portion may correspond to the high-frequency spectrum.

The electronic device may cover the wavelet spectrum of a previous level using the wavelet spectrum determined at each level. In an example, covering the wavelet spectrum may represent replacing a specific region of the wavelet spectrum.

In the example of FIG. 6, the electronic device may determine a multi-level wavelet spectrum 615 through the MDWT 610 including four DWTs in total by covering the low-frequency spectrum of the second level wavelet spectrum 612 using the first level wavelet spectrum 611, covering the low-frequency spectrum of the third level wavelet spectrum 613 using the second level wavelet spectrum 612 covered with the first level wavelet spectrum 611, and covering the low-frequency spectrum of the fourth level wavelet spectrum 614 using the third level wavelet spectrum 613 covered with the second level wavelet spectrum 612. Here, the wavelet spectra at which different patches are located within the multi-level wavelet spectrum 615 may have different levels within the multi-level wavelet spectrum 615.

According to an example, in the wavelet spectra 611, 612, 613, 614, and 615 determined through the DWT, the upper left region may be a low-frequency component region corresponding to the low-frequency spectrum, and the upper right region, the lower left region, and the lower right region may be high-frequency component regions corresponding to the high-frequency spectrum.

Here, for the purpose of description, it is described that the electronic device performs the multi-level DWT in a predetermined order and then performs the multi-level covering of the wavelet spectrum. However, in examples, the order of performance between the multi-level DWT and the multi-level covering is not limited, and the MDWT 610 may also be performed in another suitable manner or order. For example, the multi-level DWT may be performed in a different order, and/or the covering at each level may be performed after performing the DWT at each level.

The electronic device may perform post-processing (e.g., denoising) on the multi-level wavelet spectrum 615 determined through the MDWT 610 and perform the IMDWT 620 on the post-processed multi-level wavelet spectrum 615 to generate an HR image.

In the example of FIG. 6, the electronic device may determine a 16×16 image based on a high-frequency spectrum corresponding to an 8×8 low-frequency spectrum by using an inverse discrete wavelet transform (IDWT). The electronic device may determine a 32×32 image based on a high-frequency spectrum corresponding to a 16×16 low-frequency spectrum (a 16×16 image determined just before) using the IDWT. The electronic device may determine a 64×64 image based on a high-frequency spectrum corresponding to a 32×32 low-frequency spectrum (a 32×32 image determined just before) using the IDWT. The IMDWT 620 may be similar to the SISR processing, and the image may be sharpened and the resolution may be doubled by integrating a high-frequency sub-band and a low-frequency sub-band. In an example, an image having a higher resolution may be generated by modelling the SISR in the wavelet spectrum, receiving an LR input, and learning a high-frequency wavelet spectrum complementary to a low-frequency sub-band.

According to an example, by implementing the SR on the multi-level wavelet spectrum 615, low-frequency data and high-frequency data may be separated, and then the separated data may be processed separately in each model. Accordingly, the electronic device of one or more embodiments may generate a low-frequency portion corresponding to an image generated by the model that is more direct, and may improve the consistency of the results. In addition, the model may focus on sparser high-frequency data, and thus the electronic device of one or more embodiments may generate more refined image details.

FIG. 7 illustrates an example of an operation of segmenting a first spectrum into a plurality of patches according to one or more embodiments.

Referring to FIG. 7, the electronic device may segment a first spectrum (e.g., a multi-level wavelet spectrum) 700 into a plurality of patches 710. In FIG. 7, for convenience of description, the first spectrum is described as the multi-level wavelet spectrum 700, but examples are not limited thereto.

According to an example, the electronic device may segment the multi-level wavelet spectrum 700 into the plurality of patches 710 using a pyramidal tokenizer. The electronic device may set a pyramid patch size for a frequency sub-band at different levels by considering the sparsity of high-frequency components and the density of low-frequency components. For example, the electronic device may apply a smaller patch size to a frequency component with dense information, and may apply a larger patch size to a frequency component with sparse information. For example, the electronic device may determine a patch size set P by Equation 3 below, for example.

$$P = \{ {p}_{min} \times {2}^{j - 1} \} , j ∈ \{ 1 , l \} , \qquad Equation 3$$

Here, pₘᵢₙ may represent a minimum patch size of the low-frequency component in the multi-level wavelet spectrum, and may be a hyperparameter that may be set to any positive integer (e.g., 2 or 4). Also, j may represent the level number of the wavelet spectrum in which a corresponding patch is located within the multi-level wavelet spectrum 700, and I may represent a maximum level number of the multi-level wavelet spectrum 700.

According to an example, the electronic device may segment a high-frequency component region of a j-th level wavelet spectrum of the multi-level wavelet spectrum 700 into a plurality of patches having a patch size of a minimum patch size pₘᵢₙ×2^{j-1}. The electronic device may segment a first level wavelet spectrum in the multi-level wavelet spectrum 700 into a plurality of patches, each having a minimum patch size pₘᵢₙ. For example, both the low-frequency component region and the high-frequency component region within the first-level wavelet spectrum may be segmented according to the patch size pₘᵢₙ. The high-frequency component region of a second level wavelet spectrum of the multi-level wavelet spectrum 700 may be segmented into the plurality of patches having a patch size of the minimum patch size pₘᵢₙ×2. The high-frequency component region of a third level wavelet spectrum of the multi-level wavelet spectrum 700 may be segmented into the plurality of patches having a patch size of the minimum patch size pₘᵢₙ×4. The multi-level wavelet spectrum 700 may be segmented into the plurality of patches 710 in the form of pyramid patches with the patch size gradually increasing from the upper left end to the lower right end.

In the example of FIG. 7, when pₘᵢₙ of the multi-level wavelet spectrum 700 is 2 and the level number I is 3, the set of patch sizes of the multi-level wavelet spectrum 700 may be P={2,4,8}. For example, when the patch size corresponding to the first level wavelet spectrum having a size of 16×16 is 2×2, the low-frequency component region and the high-frequency component region of the first level wavelet spectrum may be segmented into the plurality of patches having a size of 2×2. When the patch size corresponding to the second level wavelet spectrum having a size of 32×32 is 4×4, the low-frequency component region covered by the first level wavelet spectrum at the upper left end in the second level wavelet spectrum may be segmented into the plurality of 2×2 patches, and the second level wavelet spectrum in the multi-level wavelet spectrum 700 including three high-frequency component regions at the lower left end, the upper right end, and the lower right end may be segmented into the plurality of patches having a size 4× 4. When the patch size corresponding to the third level wavelet spectrum having a size of 64×64 is 8×8, the low-frequency component region covered by the first level wavelet spectrum and the second level wavelet spectrum at the upper left end in the third level wavelet spectrum may be segmented into the plurality of patches having a size of 2×2 and the plurality of patches having a size of 4×4, and the third level wavelet spectrum in the multi-level wavelet spectrum 700 including three high-frequency component regions at the lower left end, the upper right end, and the lower right end may be segmented into the plurality of patches having a size 8×8. The electronic device may determine patches having different patch sizes by implementing pyramid patching over the entire multi-level wavelet spectrum 700.

According to the pyramid tokenizer method for the multi-level wavelet spectrum 700, a relatively small patch may be a patch corresponding to dense low-frequency information or low-frequency components in the image, and a relatively large patch may be a patch corresponding to sparse high-frequency information or high-frequency components in the image. Accordingly, the pyramid tokenizer method may provide a more balanced distribution of information within patches of the image. Also, as the level number of the wavelet spectrum of each level within the multi-level wavelet spectrum 700 increases, the patch size used to segment the high-frequency component region of the wavelet spectrum of the corresponding level may increase. The patch size of the high-frequency component region of the spectrum at a lower level (e.g., the j-th level) may be smaller than the patch size of the high-frequency component region of the spectrum at a higher level (e.g., a (j+1)-th level).

According to an example, the electronic device may segment the multi-level wavelet spectrum 700 into the plurality of patches having different patch sizes, and the patch size of each of the plurality of patches may be determined based on the level number j of the wavelet spectrum at which the patch is located in the multi-level wavelet spectrum 700 and the minimum patch size pₘᵢₙ of the low-frequency component of the multi-level wavelet spectrum 700. For example, the electronic device may determine the patch size corresponding to each level based on a predetermined minimum patch size and each level number of the plurality of levels, and segment each of the levels of the multi-level wavelet spectrum 700 into the plurality of patches according to the corresponding patch size. For example, the patch sizes of the plurality of patches within the multi-level wavelet spectrum 700 may gradually increase from the upper left end to the lower right end.

FIG. 8 illustrates an example of an operation of encoding a plurality of patches of a first spectrum according to one or more embodiments.

Referring to FIG. 8, a plurality of tokens 820 for a plurality of patches 810 may be determined by encoding the plurality of patches 810 segmented from a first spectrum based on positions of corresponding patches.

According to an example, the electronic device may segment the multi-level wavelet spectrum into the plurality of patches 810, and utilize a four-dimensional (4D) positional encoding method using spectral information, in order to apply a transformer to the pyramid tokenizer method. For example, the plurality of patches 810 of the multi-level wavelet spectrum may each be encoded with 4D positional encoding information.

The electronic device may encode the plurality of patches 810 based on a level number for a corresponding patch for each of the patches, a position of the corresponding patch within a corresponding level of the multi-level wavelet spectrum, a position of the corresponding patch on a vertical axis, and a position of the corresponding patch on a horizontal axis. For example, the electronic device may integrate the level number j, component information, and a two-dimensional (2D) absolute position in the multi-level wavelet spectrum into 4D positional encoding information [j, L|HL|HH|LH, x, y] (j∈[1,I], L=0, HL=1, HH=2, LH=3), and add the 4D positional encoding information as a token through a fully connected (FC) layer. The encoding process for transforming the patch into the token may vary depending on examples.

In the 4D positional encoding information, a value of a first dimension j may represent the level number, and a value of a second dimension may represent a position within a spectrum of a current level of the patch. For example, as values for the second dimension, “0” may represent an upper left end L, “1” may represent an upper right end HL, “2” may represent a lower right end HH, and “3” may represent a lower left end LH. A value x of a third dimension may represent a horizontal axis position Posₕ of the corresponding patch, and a value y of a fourth dimension may represent a vertical axis position Pos_{w} of the corresponding patch. In the example of FIG. 8, 4D positional encoding information 821 of a patch 811 at the upper right end of the multi-level wavelet spectrum may be [3, 1, Posₕ, Pos_{w}]. The 4D positional encoding information 821 may represent that a corresponding patch is positioned at the upper right end of the third level wavelet spectrum, and 2D absolute position coordinates may be (Posₕ, Pos_{w}). The electronic device may determine a token for the patch based on the 4D positional encoding information 821. The method of determining the numerical value of the absolute position coordinates in the 4D positional encoding information may vary depending on examples.

The electronic device may determine a plurality of tokens containing noise having information about the spectrum by performing the 4D positional encoding on each of the plurality of patches 810. For example, the electronic device may determine the plurality of tokens containing noise by tokenizing the wavelet spectrum using a convolution operation (e.g., Conv2d ( )).

Here, the encoding may be performed for each patch, and when each patch corresponds to a low-frequency component or a high-frequency component, the determined plurality of tokens containing noise may include one or more tokens containing noise corresponding to a low-frequency component containing noise and one or more tokens containing noise corresponding to a high-frequency component containing noise.

The pyramid tokenizer method of one or more embodiments may reduce the amount of computation caused by the self-attention mechanism within the transformer.

However, the example of the method of segmenting the multi-level wavelet spectrum is not limited thereto, and the electronic device may segment the multi-level wavelet spectrum into a plurality of patches having the same patch size or may segment the multi-level wavelet spectrum by other methods. In addition, the example of the method of encoding the patches into tokens is not limited thereto, and the electronic device may perform the transform between the tokens and other patches in which the corresponding tokens are available for subsequent processing.

FIG. 9 illustrates an example of an operation of sampling a plurality of tokens for each of a plurality of patches according to one or more embodiments.

Referring to FIG. 9, the electronic device may sample a plurality of tokens 901 determined for a plurality of patches of a first spectrum into a predetermined number of a plurality of tokens 902 to perform denoising. For example, in operation 910, the electronic device may sample the plurality of tokens 901 into a predetermined number of tokens to perform denoising by performing cross attention on the plurality of tokens 901.

Depending on various situations in which the image processing method is used, the size of the input LR image may be different, and therefore the number of tokens determined from the LR image may be different. According to an example, for convenience of model training, the electronic device may utilize a MSTS method for different numbers of tokens to process the SISR having various magnification scales.

The plurality of tokens 901 containing noise determined by patch processing may have a first quantity corresponding to the size of the first spatial domain image. The first quantity may be any quantity.

In the example of FIG. 9, when the number of plurality of tokens 901 containing noise determined by patch processing is M, the electronic device may obtain the N tokens 902 containing noise having a format (N, C) by performing a cross-attention operation on the M tokens 901 containing noise having an input format (M, C) based on learnable parameters having a format (N, C). Here, N may represent the predetermined number of tokens available for denoising in the transformer, and C may represent a channel dimension of the token. The electronic device may determine the plurality of tokens 902 containing noise of the predetermined number N to be available for denoising by performing the cross-attention on the plurality of tokens 901 containing noise having the first quantity M.

According to an example, the electronic device may determine a low-frequency component

$${x}_{L}^{1}$$

containing noise and a high-frequency component set X_{H} containing noise of one or more high-frequency components

$${X}_{H}^{j}$$

containing noise. The electronic device may determine a low-frequency component containing noise and high-frequency components containing noise of the plurality of tokens 902 containing noise of the predetermined number N by Equations 4 and 5 below, for example.

$${f}_{L}^{1} , {F}_{H}^{1} = MSTS ( Conv 2 {d}^{1} ( {x}_{L}^{1} , {X}_{H}^{1} ) ) \qquad Equation 4$$

$${F}_{H}^{j} = MSTS ( Conv 2 {d}^{j} ( {X}_{H}^{j} ) ) , j ∈ \{ 2 , l \} \qquad Equation 5$$

Here,

$${f}_{L}^{1}$$

may represent a low-frequency component containing noise determined through MSTS,

$${F}_{H}^{1}$$

may represent a high-frequency component containing noise of the first level wavelet spectrum determined through MSTS,

$${F}_{H}^{j}$$

may represent high-frequency components containing noise of the second level wavelet spectrum or a higher level wavelet spectrum determined through MSTS, and Conv2d( ) may represent convolution.

The electronic device of one or more embodiments may perform the cross-attention operation on the plurality of tokens 901 containing noise determined by the patch processing to set the number of the plurality of tokens 901 containing noise to the predetermined number, thereby ensuring that the same number of tokens are input to a subsequent model regardless of the size of the input image to be advantageous for model training and increase the convenience of model training. In addition, the image processing method of one or more embodiments for image SR supporting multiple scale according to an example may effectively process a multiple scale task without changing the model itself through a main network that shares scale-related modules and parameters.

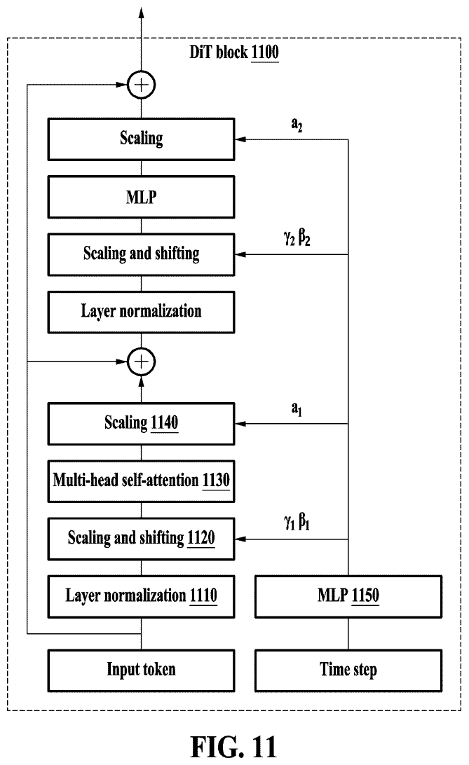

FIGS. 10 and 11 illustrate an example of an operation of denoising a plurality tokens according to one or more embodiments.

Referring to FIG. 10, the electronic device may denoise a plurality of tokens 1020 and 1030 based on the LR image. The electronic device may denoise the plurality of tokens 1020 and 1030 containing noise to determine a plurality of denoised tokens 1095 including a denoised low-frequency component and a denoised high-frequency component. In FIG. 10, for convenience of description, a token corresponding to the low-frequency component containing noise may also be referred to as a low-frequency noise token 1020, and a token corresponding to the high-frequency component containing noise may also be referred to as a high-frequency noise token 1030.

The electronic device may determine the plurality of denoised tokens 1095 by performing the denoising on each of the low-frequency noise token 1020 and the high-frequency noise token 1030 based on the LR image (e.g.,

$${I}_{{t}_{lr}}^{spa}$$

of FIG. 3), to which noise is not added, corresponding to the first spatial domain image. The electronic device may implement the image SR using the LR images as a guide condition based on the DiT image generation model.

The electronic device may determine an LR token 1010 from the LR image, to which noise is not added, through patch processing. The electronic device may determine the LR token 1010 by performing patching and encoding processing directly on the LR image. For example, the electronic device may segment the LR image into a plurality of patches having a minimum patch size Pₘᵢₙ and perform the positional encoding (e.g., 4D positional encoding) on the plurality of patches. Alternatively, the electronic device may segment the LR image into a plurality of patches in the same manner as the multi-level wavelet spectrum segmentation, and perform positional encoding (e.g., 4D positional encoding) on the plurality of patches, but examples are not limited thereto.

According to an example, LR feature distributions used when generating a high-frequency sub-band and a low-frequency sub-band are different from each other. Accordingly, in order to guide the generation by utilizing LR information more effectively, the electronic device of one or more embodiments may process the low-frequency sub-band and the high-frequency sub-band, respectively, using a low-frequency decoder 1040 and a high-frequency decoder 1070.

The electronic device may perform denoising on the low-frequency noise token 1020 through the low-frequency decoder 1040 according to the guide of the LR image to determine a low-frequency denoised token 1050 corresponding to the denoised low-frequency component. In addition, the electronic device may perform denoising on the high-frequency noise token 1030 through the high-frequency decoder 1070 according to the guide of the LR image to determine a high-frequency denoised token 1080 corresponding to the denoised high-frequency component.

The low-frequency decoder 1040 and the high-frequency decoder 1070 may include a plurality of DiT blocks and one or more layer normalization blocks. One or more examples of the DiT block included in the low-frequency decoder 1040 and the high-frequency decoder 1070 will be described in detail below with reference to FIG. 11.

The electronic device may concatenate (Cat) the LR token 1010 and the low-frequency noise token 1020 corresponding to the low-frequency component containing noise, and determine a low-frequency denoised token related to the low-frequency component by performing denoising on the concatenated token using the low-frequency decoder 1040. The electronic device may separate an output of the low-frequency decoder 1040 into the low-frequency denoised token 1050 of the denoised low-frequency component and an LR token 1060.

The electronic device may concatenate (Cat) the LR token 1060 output from and separated by the low-frequency decoder 1040 and the high-frequency noise token 1030 corresponding to the high-frequency component containing noise, and determine a high-frequency denoised token related to the high-frequency component by performing denoising on the concatenated token using the high-frequency decoder 1070. The electronic device may separate an output of the high-frequency decoder 1070 into the high-frequency denoised token 1080 of the denoised high-frequency component and an LR token 1090.

The electronic device may determine frequency components

$${f}_{L}^{1} , {F}_{H}^{1} , and {F}_{H}^{j}$$

containing noise, and determine a denoised low-frequency component

$${g}_{L}^{1}$$

and a denoised high-frequency component G_{H} according to a guide gₗᵣ of information of the LR image

$${I}_{lr}^{spa}$$

by Equations 6 and 7 below, for example.

$${g}_{L}^{1} = Split ( LFDec ( Concat ( {Emb}_{lr} ( {I}_{lr}^{spa} ) , {f}_{L}^{1} ) , t ) ) \qquad Equation 6$$

$${G}_{H} = HFDec ( Concat ( {g}_{lr} , {F}_{H} ) , t ) \qquad Equation 7$$

Here,

$${f}_{L}^{1}$$

may represent a low-frequency component containing noise determined by Equation 4,

$${I}_{lr}^{spa}$$

may represent the LR image, to which noise is not added, and F_{H} may represent a set of a high-frequency component

$${F}_{H}^{1}$$

containing noise determined by Equation 4 and high-frequency components

$${F}_{H}^{j}$$

containing noise determined by Equation 5. In addition, Concat( ) may represent concatenation processing for tokens.

In the example of FIG. 10, for the purpose of description, the denoising processing of the low-frequency decoder 1040 and the high-frequency decoder 1070 is illustrated as a serial process, and the information of the LR image used by the high-frequency decoder 1070 is illustrated as having undergone the processing of the low-frequency decoder 1040, but examples are not limited thereto. The electronic device may perform the processing of the low-frequency decoder 1040 and the high-frequency decoder 1070 in parallel, and/or may perform the processing of the high-frequency decoder 1070 first and then perform the processing of the low-frequency decoder 1040.

When the LR image has more complex 2D information than simple conditional data (e.g., time steps or classes), the electronic device of one or more embodiments may more effectively extract and utilize the LR information in the SISR by denoising the plurality of tokens using the LR image.

The electronic device may determine the denoised tokens 1095 by concatenating the low-frequency denoised token 1050 and the high-frequency denoised token 1080. After determining the denoised tokens 1095 including the denoised low-frequency component and the denoised high-frequency component, the electronic device may perform inverse patch processing on the denoised tokens 1095 to restore a multi-level wavelet spectrum.

The electronic device may determine a second spectrum obtained by denoising the first spectrum, based on the plurality of denoised tokens 1095. In an example, the electronic device may perform FC processing on the denoised tokens 1095 to determine a denoised multi-level wavelet spectrum. Here, for convenience of description, the second spectrum may also be referred to as the denoised multi-level wavelet spectrum. For example, the electronic device may determine the denoised multi-level wavelet spectrum by performing the FC processing on the plurality of denoised tokens 1095 using a plurality of FC layers (e.g., a first FC layer FC1, a second FC layer FC2, and a third FC layer FC3). The number of FC layers

$$F {C}_{out}^{j} , j ∈ \{ 1 , l \}$$

may be determined based on the level number for the multi-level wavelet transform. In addition, each FC layer transforms a tokens of a corresponding level into a wavelet spectrum of the corresponding level. In an example, an inverse patch operation of determining a wavelet spectrum based on the plurality of denoised tokens 1095 may be the inverse process of the patch operation.

Referring to FIG. 11, a DiT block 1100 may include a plurality of perception layers. The DiT block 1100 may perform at least one of a layer normalization operation 1110, a scaling and shifting operation 1120, a multi-head self-attention operation 1130, a scaling operation 1140, and a multi-layer perceptron (MLP) operation 1150 on an input token based on a time step using each perception layer. The structure and operation of the DiT block 1100 illustrated in FIG. 11 are examples for description, and examples are not limited thereto.

FIG. 12 illustrates an example of an operation of reconstructing sampled tokens according to one or more embodiments.

Referring to FIG. 12, the electronic device may determine a plurality of denoised tokens 1203 by performing grid sampling on the sampled tokens, and determine a second spectrum based on the plurality of denoised tokens 1203 using an FC layer. In FIG. 10, a multiple scale token generation processing process is illustrated as an example.

The electronic device may determine the denoised tokens 1203 of a first quantity for FC by performing grid sampling on a plurality of denoised tokens 1201 of a predetermined number (e.g., a second quantity) determined by the inverse patch processing.

For example, the electronic device may reconstruct N tokens determined by a low-frequency decoder or a high-frequency decoder in operation 1210, sample the reconstructed tokens to a predetermined size by performing the grid sampling on the reconstructed tokens in operation 1220, and determine M tokens by reconstructing the sampled results again in operation 1230. The electronic device may determine M denoised tokens 1203 by performing multiple data processing again on the input tokens by performing the FC processing on the determined M tokens through an FC layer 1240. The MSTS process may be the inverse process of the MSTS process. The denoised tokens 1203 of the first quantity M determined through the multiple scale token generation may be input to the FC layer and used to determine a denoised multi-level wavelet spectrum.

In an example, a denoised low-frequency component

$${g}_{L}^{1}$$

and a denoised high-frequency component G_{H} may be determined, and the denoised low-frequency component

$${g}_{L}^{1}$$

and the denoised high-frequency component G_{H} included in a plurality of denoised tokens 1201 may be transformed by Equation 8 below, for example.

$$\tilde{X} = F {C}^{J} ( MSTG ( Concat ( {g}_{L}^{1} , {G}_{H} ) ) ) , j ∈ \{ 1 , l \} \qquad Equation 8$$

Here, MSTG( ) may represent the multiple scale token generation operation, FC^{j}( ) may represent the FC processing, and Concat( ) may represent the concatenation processing.

The IMDWT may be performed on a second multi-level wavelet spectrum to determine the HR second spatial domain image

$${I}_{{0}_{sr}^{spa}} .$$

The electronic device may add noise to the second spatial domain image in a current time step and then use the second spatial domain image with the noise added, as the first spatial domain image of repeated determinations.

In an example, the electronic device may determine a denoised multi-level wavelet spectrum \tilde{X}, and determine the HR second spatial domain image

$${I}_{{0}_{sr}^{spa}}$$

based on the denoised multi-level wavelet spectrum by Equation 9 below, for example.

$${I}_{{0}_{sr}^{spa}} = iMWDT ( \tilde{X} , l ) \qquad Equation 9$$

Here, iMWDT( ) may represent the IMDWT.

During a process of training of the transformer-based diffusion model, the electronic device may determine a loss function of the model using an adversarial loss function and a reconstruction loss function. The electronic device may optimize a generator and a discriminator using the adversarial loss function. The electronic device may determine a loss function of the discriminator, for example, by Equations 10 and 11 below, for example.

$${ℒ}_{adv}^{D} = - log ( D ( {I}_{t - {1}_{hr}^{spa}} , {I}_{{t}_{hr}^{spa}} , t ) ) + log ( D ( {I}_{t - {1}_{sr}^{spa}} , {I}_{{t}_{hr}^{spa}} , t ) ) \qquad Equation 10$$

$${ℒ}_{adv}^{G} = - log ( D ( {I}_{t - {1}_{sr}^{spa}} , {I}_{{t}_{hr}^{spa}} , t ) ) \qquad Equation 11$$

Here,

$${ℒ}_{adv}^{D}$$

may represent the loss of the discriminator, and

$${ℒ}_{adv}^{G}$$

may represent the loss that the discriminator returns to the generator.

According to an example, the electronic device may limit the generation of frequency domain information by a reconstruction loss function

$${ℒ}_{rec}$$

of Equation 12 below, for example.

$${ℒ}_{r e c} = {‖ {I}_{{0}_{sr}^{spa}} - {I}_{h r}^{spa} ‖}_{1}$$

The electronic device may determine a final loss function [symbol] ^{G} as shown in Equation 13 below, for example.

$${ℒ}^{G} = λ {ℒ}_{adv}^{G} + {ℒ}_{r e c}$$

Here, λ is a hyperparameter and may be, for example, 0.05.

The electronic device may adjust the diffusion model based on the loss of the image processing method according to an example during the training period of the diffusion model through the loss function according to Equation 13.

FIG. 13 illustrates an example of an electronic device according to one or more embodiments.

Referring to FIG. 13, an electronic device 1300 may include a wavelet transformer 1310, a patch processor 1320, a denoising processor 1330, an inverse patch processor 1340, and an inverse wavelet transformer 1350. As shown in FIG. 13, each of the components 1310, 1320, 1330, 1340, and 1350 included in the electronic device may be implemented as a separate device or hardware, but may be implemented by, comprise, or be included in one device (e.g., a processor 1410 of FIG. 14) or one component may be implemented by a plurality of components according to an example.

The wavelet transformer 1310 may determine a first spectrum including a plurality of frequency components for an image containing noise determined at each of a plurality of levels by transforming the image into a frequency domain at the plurality of levels. The patch processor 1320 may determine a plurality of tokens for a plurality of patches by segmenting the first spectrum into the plurality of patches and encoding the plurality of patches based on positions of corresponding patches. The denoising processor 1330 may denoise the plurality of tokens based on the image. The inverse patch processor 1340 may determine a second spectrum obtained by denoising the first spectrum, based on the plurality of denoised tokens. The inverse wavelet transformer 1350 may determine an HR image with an increased resolution of the image by inversely transforming the second spectrum into a spatial domain at the plurality of levels.

FIG. 14 illustrates an example of an electronic device according to one or more embodiments.

Referring to FIG. 14, an electronic device 1400 may include a processor 1410. The processor 1410 may be or include one or more processors. The electronic device 1400 may further include a memory 1420. The memory 1420 may be or include one or more memories.

The memory 1420 may store instructions (or programs) executable by the processor 1410. For example, the instructions may include instructions to perform an operation of the processor 1410 and/or an operation of each component of the processor 1410. For example, the memory 1420 may be or include a non-transitory computer-readable storage medium storing instructions that, when executed by the processor 1410, configure the processor 1410 to perform any one, any combination, or all of the operations and/or methods disclosed herein with reference to FIGS. 1-13.

The processor 1410 may be a device that executes instructions or programs or controls the electronic device 1400 and may include, for example, various processors such as a central processing unit (CPU) and a graphics processing unit (GPU). The processor 1410 may determine a first spectrum including a plurality of frequency components for an image containing noise determined at each of a plurality of levels by transforming the image into a frequency domain at the plurality of levels. The processor 1410 may determine a plurality of tokens for a plurality of patches by segmenting the first spectrum into the plurality of patches and encoding the plurality of patches based on positions of corresponding patches. The processor 1410 may denoise the plurality of tokens based on the image. The processor 1410 may determine a second spectrum obtained by denoising the first spectrum, based on the plurality of denoised tokens. The processor 1410 may determine an HR image with an increased resolution of the image by inversely transforming the second spectrum into a spatial domain at the plurality of levels.

The processor 1410 may perform a wavelet transform on the image at a first level among the plurality of levels, and, at each of the remaining levels except for the first level among the plurality of levels, perform the wavelet transform on a low-frequency component determined through the wavelet transform at a previous level of a corresponding level. The processor 1410 may determine a token for the image by encoding the image, and determine a token for a patch representing a low-frequency component and tokens for patches representing high-frequency components based on the token for the image. The processor 1410 may sample the plurality of tokens into a predetermined number of tokens to perform denoising by performing cross attention on the plurality of tokens. The processor 1410 may determine a plurality of denoised tokens by performing grid sampling on the sampled tokens, and determine a second spectrum based on the plurality of denoised tokens using an FC layer. The processor 1410 may denoise the plurality of tokens using a decoder including a plurality of DiT blocks. The processor 1410 may determine a patch size corresponding to each level based on a predetermined minimum patch size and each level number of the plurality of levels, and segment each of the levels of the first spectrum into the plurality of patches according to the corresponding patch size. The processor 1410 may encode the plurality of patches based on a level number for a corresponding patch for each of the patches, a position of the corresponding patch within a corresponding level of the first spectrum, a position of the corresponding patch on a vertical axis, and a position of the corresponding patch on a horizontal axis. The processor 1410 may increase the resolution of the image by repeatedly performing the determining of the first spectrum for the image to the determining of the HR image a predetermined number of iterations.

The plurality of patches may include a patch representing a low-frequency component determined at a last level among the plurality of levels and patches representing high-frequency components determined at the remaining levels among the plurality of levels, excluding the last level.

In addition, the electronic device 1400 may process the operations described above.

The electronic devices, wavelet transformers, patch processors, denoising processors, inverse patch processors, inverse wavelet transformers, processors, memories, electronic device 1300, wavelet transformer 1310, patch processor 1320, denoising processor 1330, inverse patch processor 1340, inverse wavelet transformer 1350, electronic device 1400, processor 1410, and memory 1420 described herein, including descriptions with respect to respect to FIGS. 1-14, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-14 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An electronic device comprising:
one or more processors comprising processing circuitry; and
memory comprising one or more storage media storing instructions that, when executed individually or collectively by the one or more processors, cause the electronic device to:
determine a first spectrum comprising a plurality of frequency components for an image containing noise determined at each of a plurality of levels by transforming the image into a frequency domain at the plurality of levels;
determine a plurality of tokens for a plurality of patches by segmenting the first spectrum into the plurality of patches and encoding the plurality of patches based on positions of corresponding patches;
denoise the plurality of tokens based on the image;
determine a second spectrum obtained by denoising the first spectrum, based on the plurality of denoised tokens; and
generate a high-resolution (HR) image with an increased resolution of the image by inversely transforming the second spectrum into a spatial domain at the plurality of levels.

2. The electronic device of claim 1, wherein, for the determining of the first spectrum, the execution of the instructions causes the electronic device to:
perform a wavelet transform on the image at a first level among the plurality of levels; and
perform a wavelet transform on a low-frequency component determined through the wavelet transform at a previous level of a corresponding level, at each of remaining levels among the plurality of levels, excluding the first level.

3. The electronic device of claim 1, wherein the plurality of patches comprises a patch representing a low-frequency component determined at a last level among the plurality of levels and patches representing high-frequency components determined at the remaining levels among the plurality of levels, excluding the last level.

4. The electronic device of claim 3, wherein, for the denoising of the plurality of tokens, the execution of the instructions causes the electronic device to:
determine a token for the image by encoding the image; and
based on the token for the image, determine a token for the patch representing the low-frequency component and tokens for the patches representing the high-frequency components.

5. The electronic device of claim 1, wherein, for the determining of the second spectrum, the execution of the instructions causes the electronic device to sample the plurality of tokens into a predetermined number of tokens to perform denoising by performing cross attention on the plurality of tokens.

6. The electronic device of claim 5, wherein, for the determining of the second spectrum, the execution of the instructions causes the electronic device to:
determine the plurality of denoised tokens by performing grid-sampling on the sampled tokens; and
determine the second spectrum based on the plurality of denoised tokens using a fully connected layer.

7. The electronic device of claim 1, wherein, for the denoising of the plurality of tokens, the execution of the instructions causes the electronic device to denoise the plurality of tokens using a decoder comprising a plurality of diffusion transformer (DiT) blocks.

8. The electronic device of claim 1, wherein, for the determining of the plurality of tokens for the plurality of patches, the execution of the instructions causes the electronic device to:
determine a patch size corresponding to each level based on a predetermined minimum patch size and each level number of the plurality of levels; and
segment each level of the first spectrum into the plurality of patches according to the corresponding patch size.

9. The electronic device of claim 1, wherein, for the determining of the plurality of tokens, the execution of the instructions causes the electronic device to encode the plurality of patches based on a level number for a corresponding patch for each of the patches, a position of the corresponding patch within a corresponding level of the first spectrum, a position of the corresponding patch on a vertical axis, and a position of the corresponding patch on a horizontal axis.

10. The electronic device of claim 1, wherein the execution of the instructions causes the electronic device to increase the resolution of the image by performing a plurality of iterations of the determining of the first spectrum for the image to the generating of the HR image a predetermined number of iterations, wherein the generated HR image of an iteration is the image of a subsequent iteration.

11. A processor-implemented method comprising:
determining a first spectrum comprising a plurality of frequency components for an image containing noise determined at each of a plurality of levels by transforming the image into a frequency domain at the plurality of levels;
determining a plurality of tokens for a plurality of patches by segmenting the first spectrum into the plurality of patches and encoding the plurality of patches based on positions of corresponding patches;
denoising the plurality of tokens based on the image;
determining a second spectrum obtained by denoising the first spectrum, based on the plurality of denoised tokens; and
generating a high-resolution (HR) image with an increased resolution of the image by inversely transforming the second spectrum into a spatial domain at the plurality of levels.

12. The method of claim 11, wherein the determining of the first spectrum comprises:
performing a wavelet transform on the image at a first level among the plurality of levels; and
performing a wavelet transform on a low-frequency component determined through the wavelet transform at a previous level of a corresponding level, at each of remaining levels among the plurality of levels, excluding the first level.

13. The method of claim 11, wherein the plurality of patches comprises a patch representing a low-frequency component determined at a last level among the plurality of levels and patches representing high-frequency components determined at the remaining levels among the plurality of levels, excluding the last level.

14. The method of claim 13, wherein the denoising of the plurality of tokens comprises:
determining a token for the image by encoding the image; and
based on the token for the image, determining a token for the patch representing the low-frequency component and tokens for the patches representing the high-frequency components.

15. The method of claim 11, wherein the determining of the second spectrum comprises sampling the plurality of tokens into a predetermined number of tokens to perform denoising by performing cross attention on the plurality of tokens.

16. The method of claim 15, wherein the determining of the second spectrum comprises:
determining the plurality of denoised tokens by performing grid-sampling on the sampled tokens; and
determining the second spectrum based on the plurality of denoised tokens using a fully connected layer.

17. The method of claim 11, wherein the denoising of the plurality of tokens comprises denoising the plurality of tokens using a decoder comprising a plurality of diffusion transformer (DiT) blocks.

18. The method of claim 11, wherein the determining of the plurality of tokens for the plurality of patches comprises:
determining a patch size corresponding to each level based on a predetermined minimum patch size and each level number of the plurality of levels; and
segmenting each level of the first spectrum into the plurality of patches according to the corresponding patch size.

19. The method of claim 11, wherein the determining of the plurality of tokens comprises encoding the plurality of patches based on a level number for a corresponding patch for each of the patches, a position of the corresponding patch within a corresponding level of the first spectrum, a position of the corresponding patch on a vertical axis, and a position of the corresponding patch on a horizontal axis.

20. A processor-implemented method comprising:
generating, using a wavelet transform, a low-frequency component and a high-frequency component of an image;
performing, based on a low-resolution (LR) image, denoising on tokens respectively corresponding to the low-frequency component and the high-frequency component;
generating, based on the denoised tokens, a low-frequency component and a high-frequency component of a high-resolution (HR) image; and
generating, using an inverse wavelet transform, the HR image based on the low-frequency component and the high-frequency component of the HR image.
